(19) United States
(12) Patent Application Publication
(10) Pub. No.: US 2009/0037089 A1
(43) Pub. Date: Feb. 5, 2009

(54) Method for determining traffic information, and a device arranged to perform the method

(76) Inventors: Serhiy Tkachenko, Amsterdam (NL); John Blazey, Haarlem (NL)

Correspondence Address: HARNESS, DICKEY & PIERCE, P.L.C., P.O. BOX 8910, RESTON, VA, 20195, US

(21) Appl. No.: 11/920,776

(22) PCT Filed: Jul. 11, 2005
(86) PCT No.: PCT/NL2005/000496

§ 371 Date: Aug. 19, 2008

(51) Int. Cl. G08G 1/01; G06K 9/00

(52) U.S. Cl. 701/118; 382/104

(57) ABSTRACT

The present application relates to a method for determining traffic information. In at least one embodiment, the method includes receiving at least one photograph of a portion of the earth's surface comprising at least one road segment using an input/output device, recognizing a number of vehicles on the at least one road segment in the at least one received photograph using a processor unit, and determining traffic information based on the at least one recognized vehicle.

### FIELD OF THE INVENTION

The present invention relates to a method for determining traffic information.

Also, the present invention relates to a device arranged to perform the method.

### STATE OF THE ART

Prior art navigation devices based on GPS (Global Positioning System) are well known and are widely employed as in-car navigation systems. Such a GPS based navigation device relates to a computing device which in a functional connection to an external (or internal) GPS receiver is capable of determining its global position. Moreover, the computing device is capable of determining a route between start and destination addresses, which can be input by a user of the computing device. Typically, the computing device is enabled by software for computing a “best” or “optimum” route between the start and destination address locations from a map database. A “best” or “optimum” route is determined on the basis of predetermined criteria and need not necessarily be the fastest or shortest route.

The navigation device may typically be mounted on the dashboard of a vehicle, but may also be formed as part of an on-board computer of the vehicle or car radio. The navigation device may also be (part of) a hand-held system, such as a PDA.

By using positional information derived from the GPS receiver, the computing device can determine at regular intervals its position and can display the current position of the vehicle to the user. The navigation device may also comprise memory devices for storing map data and a display for displaying a selected portion of the map data.

Also, it can provide instructions how to navigate the determined route by appropriate navigation directions displayed on the display and/or generated as audible signals from a speaker (e.g. ‘turn left in 100 m’). Graphics depicting the actions to be accomplished (e.g. a left arrow indicating a left turn ahead) can be displayed in a status bar and also be superimposed upon the applicable junctions/turnings etc. in the map itself.

It is known to enable in-car navigation systems to allow the driver, whilst driving in a car along a route calculated by the navigation system, to initiate a route re-calculation. This is useful where the vehicle is faced with construction work or heavy congestion.

It is also known to enable a user to choose the kind of route calculation algorithm deployed by the navigation device, selecting for example from a ‘Normal’ mode and a ‘Fast’ mode (which calculates the route in the shortest time, but does not explore as many alternative routes as the Normal mode).

It is also known to allow a route to be calculated with user defined criteria; for example, the user may prefer a scenic route to be calculated by the device. The device software would then calculate various routes and weigh more favourably those that include along their route the highest number of points of interest (known as POIs) tagged as being for example of scenic beauty.

In order to determine a route between start and destination addresses, the navigation device uses map data. Depending on stored or input preferences (shortest route, fastest route, scenic route, . . . ), the navigation device computes an “optimum” route using the stored map data. However, the “optimum” route may differ from time to time, depending on the current situation on the road. It may for instance depend on the amount of vehicles on certain segments of the road, possible traffic jams, congestion, diversions etc.

US 2002/0128770 A1 describes a system to provide a driver with real-time information about the situation on the road. The system uses cameras to make pictures of the earth's surface. The cameras may be cameras positioned on the ground or may be cameras positioned on a satellite. The server transmits (part of) a picture to a navigation device mounted on a client's vehicle. The navigation device is arranged to display the received picture to allow the client to assess the situation on the road.

Known navigation devices are arranged to take into account changing road situations and conditions. Such navigation devices are arranged to receive information on traffic jams from a server. This information is used by the navigation device when planning a route or may be used to re-route an already planned route. The information about traffic jams is for instance collected using detection systems embedded in the road surface measuring the speed of the passing vehicles.

### SHORT DESCRIPTION OF THE INVENTION

It is an object of the invention to provide a method that provides an alternative way of collecting traffic information.

In order to obtain this object, the invention provides a method according to the preamble, characterized in that the method comprising the following:
receiving at least one photograph of a portion of the earth's surface comprising at least one road segment using an input/output device,
recognizing a number of vehicles on the at least one road segment in the at least one received photograph using a processor unit, and
determining traffic information based on the at least one recognized vehicle.

This method provides an alternative way to collect traffic information. The method can be executed by a computer device. Collecting traffic information using photographs, for instance taken from a satellite, is an easy and reliable way to collect traffic information.

According to an embodiment of the invention, the recognition of the number of vehicles is done using pattern recognition techniques. This is an easy and reliable way to recognize vehicles using a computer or the like.

According to an embodiment of the invention, map data is used as input for the pattern recognition techniques. This enhances the pattern recognition as cars may be easier recognized when, from the map data, it is already known where they are expected to be.

According to an embodiment of the invention, the method further comprises computing a speed of the number of recognized vehicles based on the at least one received photograph. This may be done by determining the amount of vehicles on a road or road segment, and estimating the average speed of the vehicles on that road or road segment. However, also other techniques may be used to compute or estimate the speed of vehicles.

According to an embodiment of the invention, the speed of the number of vehicles is computed by
determining a vehicle density for a road segment, and
estimating from the vehicle density an average speed of the number of recognized vehicles in the road segment. This is an advantageous way to estimate the average speed of vehicles based on only a single photograph. It is known that traffic slows down when it becomes more dense.

According to an embodiment of the invention, the vehicle density for a road segment is determined by determining a ratio between a number of pixels in the photograph belonging to a road or road segment with a first colour (n_{dark}) and a number of pixels with an other colour (nₒₜₕₑᵣ). This ratio is an indication for the amount of traffic on a road or road segment. According to this embodiment, no pattern recognition techniques need to be employed.

According to an embodiment of the invention, the speed of the number of recognized vehicles is computed by determining an amount of blur of the number of recognized vehicles. Based on this embodiment, the speed of vehicle can be computed based on a single photograph.

According to an embodiment of the invention, the method comprises:
receiving at least two photographs of a piece of the earth from a photographing device, the first photograph being made at a first point in time and the second photograph being made at a second point in time,
recognizing a number of vehicles in the first photograph,
recognizing a number of vehicles in the second photograph,
computing the distance traveled in between the first and second photograph by at least a part of the number of vehicle recognized in both the first and second photograph,
computing a speed of the number of recognized vehicles using the computed distance and the first and second point in time. Based on two photographs, the speed of recognized vehicles can be computed in a straightforward and reliable way.

According to an embodiment of the invention, the method further comprises comparing the computed speed of the number of recognized vehicle to a reference speed associated with the road segment the number of recognized vehicles is recognized on. Based on this comparison it possible to determine if road conditions are changed, for instance whether there is a traffic jam or the like.

According to an embodiment of the invention, the method further comprises comparing the computed speed of the number of recognized vehicles to a predetermined minimum speed. According to this embodiment, there is no need to store a reference speed for each road or road section, saving memory space. The determined speed is just compared to a minimum speed.

According to an embodiment of the invention, the method further comprises
determining the positions of the recognized vehicles,
comparing the determined position with map data, the map data comprising information about parking places,
determining the availability of the parking places. This way information can be collected about the availability of parking places which can be used to guide a user to an available parking place.

According to an embodiment of the invention, wherein the method further comprises:
compiling a signal comprising the determined traffic information,
transmitting the compiled signal. The determined traffic information may for instance be information about the computed speed of the at least one recognized vehicle or the availability of parking places. In case the traffic information is about the computed speed, the signal may only be compiled and transmitted if the computed speed of the at least one recognized vehicle differs from the reference speed by more than a predetermined threshold value, or is below a predetermined minimum speed. The signal may be broadcasted, but may also be transmitted in a point to point communication mode (server to navigation device).

According to a further aspect, the invention relates to a device comprising an input-output device, memory units and a processing unit the processing unit being arranged to communicate with other devices using the input-output device, and being arranged to communicate with the memory units, characterised in that the device is arranged to
receive at least one photograph of a portion of the earth's surface comprising at least one road segment using the input-output device,
recognize a number of vehicles on the at least one road segment in the at least one received photograph using the processing unit
determine traffic information based on the number of recognized vehicles.

According to an embodiment of the invention, the device is a server, arranged to compile a signal based on the determined traffic information and transmit the signal using the input-output device. By transmitting a signal comprising the determined traffic information to for instance a navigation device, the navigation device can use the information to plan a route.

According to an embodiment of the invention, the device is a navigation device arranged to plan a route.

According to an embodiment of the invention, the navigation device is arranged to plan a route based on the determined traffic information.

A further aspect of the invention relates to a vehicle, comprising a device according to the invention.

According to a further aspect, the invention relates to a computer program, when loaded on a computer arrangement, arranged to perform the method according to the invention.

According to a further aspect, the invention relates to a data carrier, comprising a computer program according to the invention.

### SHORT DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a schematic block diagram of a navigation device,

FIG. 2 schematically depicts a view of a navigation device,

FIG. 3 schematically depicts a system according to an embodiment of the invention,

FIG. 4 schematically depicts a server according to an embodiment of the invention,

FIG. 5 schematically depicts a flow diagram according to an embodiment of the invention,

FIG. 6 schematically depicts a flow diagram according to an alternative embodiment of the invention, and

FIG. 7 schematically depicts a system according to a further embodiment of the invention.

### DETAILED DESCRIPTION OF THE INVENTION

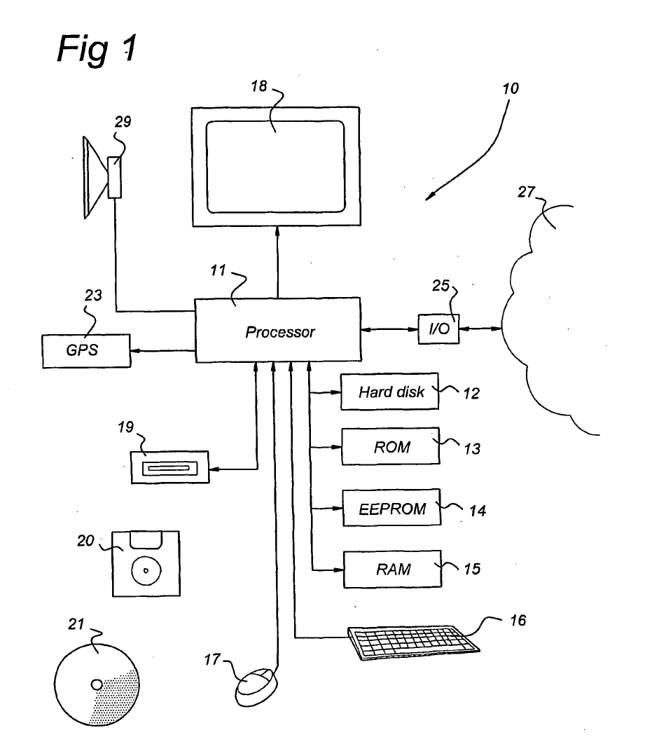

FIG. 1 shows a schematic block diagram of an embodiment of a navigation device 10, comprising a processor unit 11 for performing arithmetical operations. The processor unit 11 is arranged to communicate with memory units that store instructions and data, such as a bard disk 12, a Read Only Memory (ROM) 13, Electrically Erasable Programmable Read Only Memory (EEPROM) 14 and a Random Access Memory (RAM) 15. The memory units may comprise map data 22. This map data may be two dimensional map data (latitude and longitude), but may also comprise a third dimension (height). The map data may further comprise additional information such as information about petrol/gas stations, points of interest. The map data may also comprise information about the shape of buildings and objects along the road.

The processor unit 11 may also be arranged to communicate with one or more input devices, such as a keyboard 16 and a mouse 17. The keyboard 16 may for instance be a virtual keyboard, provided on a display 18, being a touch screen. The processor unit 11 may further be arranged to communicate with one or more output devices, such as a display 18, a speaker 29 and one or more reading units 19 to read for instance floppy disks 20 or CD ROM's 21. The display 18 could be a conventional computer display (e.g. LCD) or could be a projection type display, such as the head up type display used to project instrumentation data onto a car windscreen or windshield. The display 18 may also be a display arranged to function as a touch screen, which allows the user to input instructions and/or information by touching or pointing the display 18 with his finger.

The processor unit 11 may further be arranged to communicate with other computing devices or communication devices using an input/output device 25. The input/output device 25 is shown to be arranged to equip communication via a network 27.

The speaker 29 may be formed as part of the navigation device 10. In case the navigation device 10 is used as an in-car navigation device, the navigation device 10 may use speakers of the car radio, the board computer and the like.

The processor unit 11 may further be arranged to communicate with a positioning device 23, such as a GPS receiver, that provides information about the position of the navigation device 10. According to this embodiment, the positioning device 23 is a GPS based positioning device 23. However, it will be understood that the navigation device 10 may implement any kind of positioning sensing technology and is not limited to GPS. It can hence be implemented using other kinds of GNSS (global navigation satellite system) such as the European Galileo system. Equally, it is not limited to satellite based location/velocity systems but can equally be deployed using ground-based beacons or any other kind of system that enables the device to determine its geographical location.

However, it should be understood that there may be provided more and/or other memory units, input devices and read devices known to persons skilled in the art. Moreover, one or more of them may be physically located remote from the processor unit 11, if required. The processor unit 11 is shown as one box, however, it may comprise several processing units functioning in parallel or controlled by one main processor that may be located remote from one another, as is known to persons skilled in the art.

The navigation device 10 is shown as a computer system, but can be any signal processing system with analog and/or digital and/or software technology arranged to perform the functions discussed here. It will be understood that although the navigation device 10 is shown in FIG. 1 as a plurality of components, the navigation device 10 may be formed as a single device.

The navigation device 10 may use navigation software, such as navigation software from TomTom B.V. called Navigator. Navigator software may run on a touch screen (i.e. stylus controlled) Pocket PC powered PDA device, such as the Compaq iPaq, a telephone device as well as devices that have an integral GPS receiver 23. The combined PDA and GPS receiver system is designed to be used as an in-vehicle navigation system. The invention may also be implemented in any other arrangement of navigation device 10, such as one with an integral GPS receiver/computer/display, or a device designed for non-vehicle use (e.g. for walkers) or vehicles other than cars (e.g. aircraft).

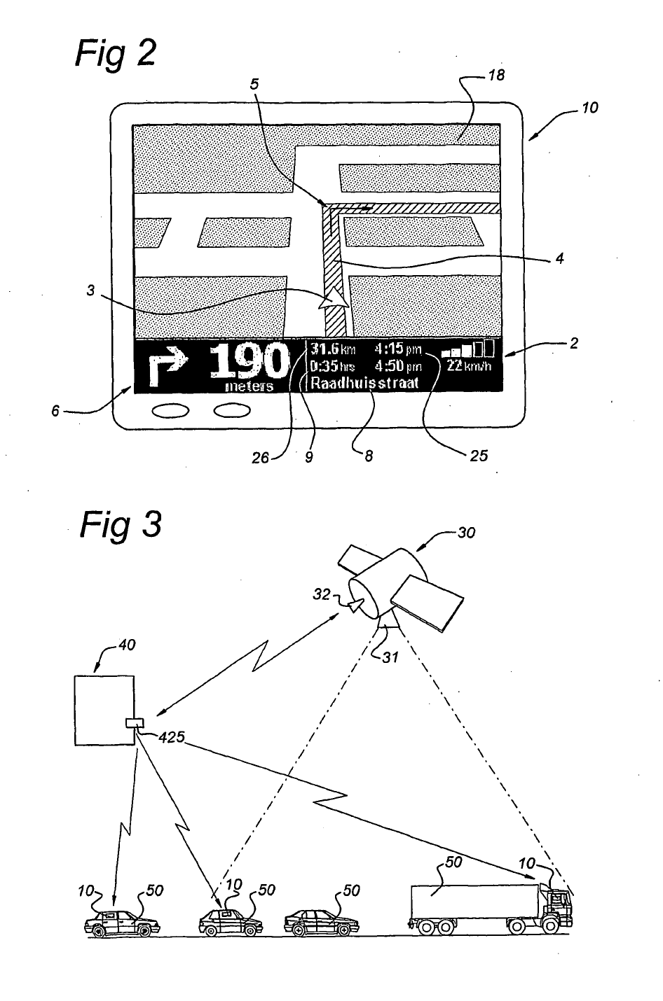

FIG. 2 depicts a navigation device 10 as described above.

Navigator software, when running on the navigation device 10, causes a navigation device 10 to display a normal navigation mode screen at the display 18, as shown in FIG. 2. This view may provide driving instructions using a combination of text, symbols, voice guidance and a moving map. Key user interface elements are the following: a 3-D map occupies most of the screen. It is noted that the map may also be shown as a 2-D map.

The map shows the position of the navigation device 10 and its immediate surroundings, rotated in such a way that the direction in which the navigation device 10 is moving is always “up”. Running across the bottom quarter of the screen may be a status bar 2. The current location of the navigation device 10 (as the navigation device 10 itself determines using conventional GPS location finding) and its orientation (as inferred from its direction of travel) is depicted by a position arrow 3. A route 4 calculated by the device (using route calculation algorithms stored in one or more of memory devices 11, 12, 13, 14, 15 as applied to map data stored in a map database in memory devices 11, 12, 13, 14, 15) is shown as darkened path. On the route 4, all major actions (e.g. turning corners, crossroads, roundabouts etc.) are schematically depicted by arrows 5 overlaying the route 4. The status bar 2 also includes at its left hand side a schematic icon depicting the next action 6 (here, a right turn). The status bar 2 also shows the distance to the next action (i.e. the right turn—here the distance is 50 meters) as extracted from a database of the entire route calculated by the device (i.e. a list of all roads and related actions defining the route to be taken). Status bar 2 also shows the name of the current road 8, the estimated time before arrival 9 (here 2 minutes and 40 seconds), the actual estimated arrival time 25 (11.36 am) and the distance to the destination 26 (1.4 km). The status bar 2 may further show additional information, such as GPS signal strength in a mobile-phone style signal strength indicator.

As already mentioned above, the navigation device may comprise input devices, such as a touch screen, that allows the users to call up a navigation menu (not shown). From this menu, other navigation functions can be initiated or controlled. Allowing navigation functions to be selected from a menu screen that is itself very readily called up (e.g. one step away from the map display to the menu screen) greatly simplifies the user interaction and makes it faster and easier. The navigation menu includes the option for the user to input a destination.

The actual physical structure of the navigation device 10 itself may be fundamentally no different from any conventional handheld computer, other than the integral GPS receiver 23 or a GPS data feed from an external GPS receiver. Hence, memory devices 12, 13, 14, 15 store the route calculation algorithms, map database and user interface software; a processor unit 12 interprets and processes user input (e.g. using a touch screen to input the start and destination addresses and all other control inputs) and deploys the route calculation algorithms to calculate the optimal route. ‘Optimal’ may refer to criteria such as shortest time or shortest distance, or some other user-related factors.

More specifically, the user inputs his start position and required destination into the navigation software running on the navigation device 10, using the input devices provided, such as a touch screen 18, keyboard 16 etc. The user then selects the manner in which a travel route is calculated: various modes are offered, such as a ‘fast’ mode that calculates the route very rapidly, but the route might not be the shortest; a ‘full’ mode that looks at all possible routes and locates the shortest, but takes longer to calculate etc. Other options are possible, with a user defining a route that is scenic—e.g. passes the most POI (points of interest) marked as views of outstanding beauty, or passes the most POIs of possible interest to children or uses the fewest junctions etc.

Roads themselves are described in the map database that is part of navigation software (or is otherwise accessed by it) running on the navigation device 10 as lines—i.e. vectors (e.g. start point, end point, direction for a road, with an entire road being made up of many hundreds of such segments, each uniquely defined by start point/end point direction parameters). A map is then a set of such road vectors, plus points of interest (POIs), plus road names, plus other geographic features like park boundaries, river boundaries etc, all of which are defined in terms of vectors. All map features (e.g. road vectors, POIs etc.) are defined in a co-ordinate system that corresponds or relates to the GPS co-ordinate system, enabling a device's position as determined through a GPS system to be located onto the relevant road shown in a map.

Route calculation uses complex algorithms that are part of the navigation software. The algorithms are applied to score large numbers of potential different routes. The navigation software then evaluates them against the user defined criteria (or device defaults), such as a full mode scan, with scenic route, past museums, and no speed camera. The route which best meets the defined criteria is then calculated by the processor unit 11 and then stored in a database in the memory devices 12, 13, 14, 15 as a sequence of vectors, road names and actions to be done at vector end-points (e.g. corresponding to pre-determined distances along each road of the route, such as after 100 meters, turn left into street x).

FIG. 3 schematically depicts a system according to the invention.

FIG. 3 depicts a satellite 30, comprising a ground photographing device 31 and a transmitter device 32. The ground photographing device 31 is arranged to take photographs of vehicles 50 on the ground surface of the earth. The vehicles 50 may comprise navigation devices 10.

The satellite 30 uses the transmitter device 32 to transmit photographs to a server 40. The satellite may also comprise a receiver. The receiver may also be formed integrally with the transmitter 32, forming a transceiver.

It will be understood by a skilled person that satellite 30 may further comprise additional devices to perform the tasks explained above. The satellite 30 may for instance comprise a processor unit and memory devices. The processor unit may be programmed to control the ground photographing device 31 to take photographs of certain locations on the ground. The photographs may then be stored in the memory devices before they are transmitted to the server 40. The server 40 comprises a receiving device. The receiving device may for instance be an input/output device 425.

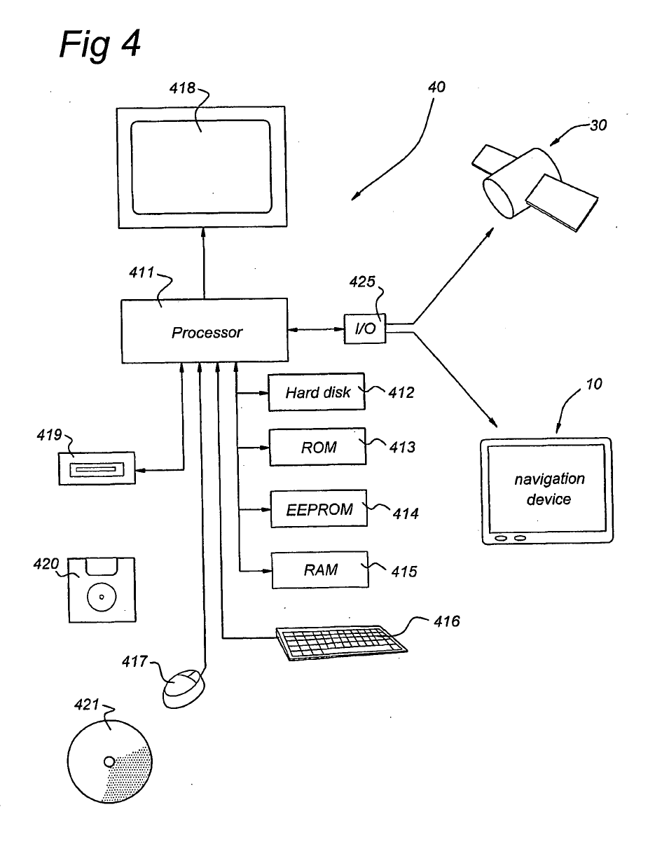

The server 40 may be positioned remote from the satellite 30. The server 40 may be a computing device, for instance such as shown in FIG. 4.

FIG. 4 shows a more detailed schematic block diagram of an embodiment of a server 40, comprising a processor unit 411. The processor unit 411 is arranged to communicate with memory units that store instructions and data, such as a hard disk 412, a Read Only Memory (ROM) 413, Electrically Erasable Programmable Read Only Memory (EEPROM) 414 and a Random Access Memory (RAM) 415. Also, processor unit 411 may be arranged for performing arithmetical operations.

The processor unit 411 may also be arranged to communicate with one or more input devices, such as a keyboard 416 and a mouse 417. The keyboard 416 may for instance be a virtual keyboard, provided on a display 418, being a touch screen. The processor unit 411 may further be arranged to communicate with one or more output devices, such as a display 418, a speaker 429 and one or more reading units 419 to read for instance floppy disks 420 or CD ROM's 421. The display 418 could be a conventional computer display (e.g. LCD) or could be any other suitable display. The display 418 may also be a display arranged to function as a touch screen, which allows the user to input instructions and/or information by touching the display 418 with his finger.

However, it should be understood that there may be provided more and/or other memory units, input devices and read devices known to persons skilled in the art. Moreover, one or more of them may be located physically remote from the processor unit 411, if required. The processor unit 411 is shown as one box, however, it may comprise several processing units functioning in parallel or controlled by one main processor that may be located remote from one another, as is known to persons skilled in the art.

The server 40 is shown as a computer system, but may be any signal processing system with analog and/or digital and/or software technology arranged to perform the functions discussed here. It will be understood that although the server 40 is shown in FIG. 4 as a plurality of components, the server 40 may be formed as a single device.

The processor unit 411 may further be arranged to communicate with other computing devices or communication devices using an input/output device 425. According to FIG. 4, the input/output device 425 enables communication between the server 40 and the satellite 30 and between the server 40 and the navigation devices 10.

The processor unit 411 may be arranged to execute program instructions stored in the memory units 412, 413, 414, 415.

The memory units 412, 413, 414, 415 may further comprise map data similar to the map data stored by memory units 12, 13, 14, 15 of the navigation device 10. Also stored in the memory units 412, 413, 414, 415 are reference speed values associated with a road segment. These reference speed values may be the speed limit for that road segment or the maximum obtainable speed under normal circumstances. It will be understood that these reference speed values are important information when planning a route, as they determine the amount of time that is probably needed for travelling a certain route. This information is needed to compute an optimum route, such as a fastest route.

### EMBODIMENT 1

According to a first embodiment, the server 40 is arranged to receive data from the satellite 30 using input/output device 425. The data comprises at least one photograph of the ground surface of the earth. The data also comprises a header comprising identification of the photograph. Further, the header may comprise information about the location and orientation of the photograph expressed in a reference system such as map coordinates, e.g. degrees of longitude and latitude, scale etc.

The processor unit 411 uses known pattern recognition algorithms to recognize and identify roads in the at least one photograph received from the satellite 30. The identification means that a recognized road or road segment is identified as being the highway A1 or E425. The recognition step may be simplified by using the map data stored in the memory units 412, 413, 414, 415 as an input for the pattern recognition algorithms. The header information may be used to match the at least one ground photograph with the map data. Based on this, roads may be recognised and identified more easily by the pattern recognition algorithms, as it is easier to find a road if it is already known where to find it.

After roads have been recognized in the at least one photograph, the processor unit 411 is arranged to recognize a number of vehicles 50 on a certain segment of the road. Again, pattern recognition algorithms known to a skilled person may be used for this.

From this, an average vehicle density (e.g. number of vehicles per 100 meter) or average vehicle distance (e.g. 50 meter) for that segment of the road can be computed based on a single photograph. It is known that the velocity of vehicles 50 depends on the amount of traffic on a road, i.e. the required distance between vehicles 50 increases with increasing speed. Therefore, an average speed of the vehicles 50 can be computed or estimated from the average vehicle density or the average vehicle distance. Of course, the maximum speed may be taken into account when determining the average speed of the vehicles 50.

This may be done by using the average vehicle density or the vehicle distance as an input for a predetermined table comprising averaged speeds that correspond to a certain vehicle density of distance. The table may be stored in the memory units 412, 413, 414, 415. However, the average speed may also be computed using a predetermined algorithm that has the average vehicle density or the vehicle distance as an input.

The average speed for that road segment is then compared to the reference speed value as stored in the memory units 412, 413, 414, 415. When a difference is detected, or when the difference exceeds a certain threshold, a signal may be transmitted to navigation devices 10 comprising information about this traffic situation. The signal may also comprise a new updated reference speed that is associated with that road segment. This information may be stored by the navigation device 10 and used when computing an “optimum route” or re-routing an already planned route. Instead of using the earlier stored reference speed values, the updated reference speed values are used when planning a route.

The average speed for the road segment may also be simply compared to a general minimum speed, that is not associated with a road segment in particular. In case the average speed is below the minimum speed, the signal may be transmitted. In this case, no reference speed needs to be stored for every road or road segment, but only one general minimum speed is stored.

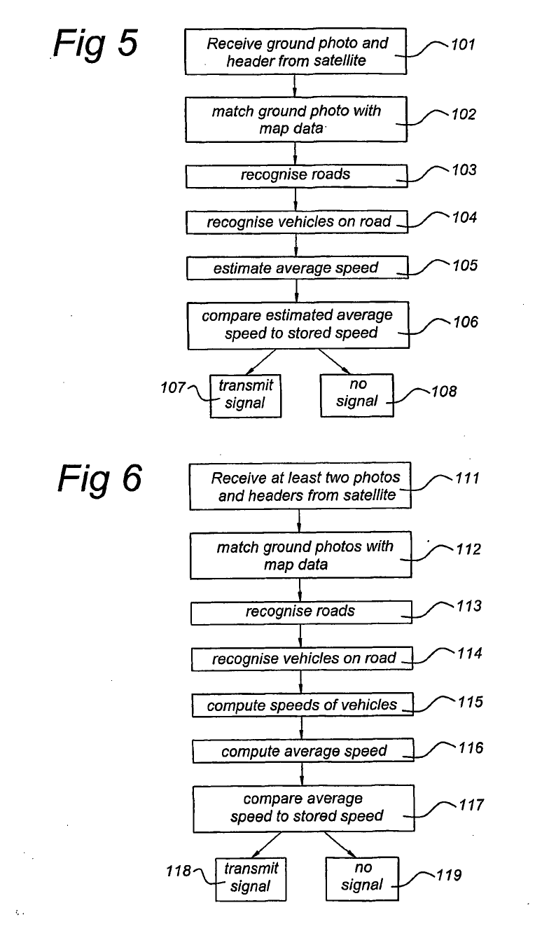

FIG. 5 shows a flow chart of the program as performed by the processor unit 411 of the server 40. In a first step 101, the input/output device 425 of the server 40 receives at least one ground photograph from the satellite 30. The ground photograph may also include header information.

In a second step 102, the processor unit 411 matches the ground photograph with map data stored in the memory units 412, 413, 414, 415 to simplify the following pattern recognition step.

In a third step 103, the processor unit 411 performs a first pattern recognition step to recognise and identify roads and other relevant items in the ground photograph as received from the satellite 30.

In a further step 104, the processor unit 411 applies a further pattern recognition algorithm to recognise vehicles on the earlier recognised roads.

In a further step 105, the processor unit 411 estimates the average speed of the vehicles on certain roads or road segments. This may be done by computing the average vehicle density or the average vehicle distance. From the average vehicle density or distance the average vehicle speed may be estimated using a predetermined algorithm stored in the one or more of memory units 412, 413, 414, 415 or by using the computed average vehicle density or distance as an entry for a stored table, to look up the estimated average vehicle speed.

In a sixth step 106, the estimated average speed is compared to the reference speed associated with that road segment as stored in the memory units 412, 413, 414, 415. If a difference is determined, or if the difference exceeds a certain predetermined threshold, the processor unit 411 compiles a signal and controls the input/output device 425 to transmit the signal as depicted in step 107. If no difference is determined or the difference does not exceed a predetermined threshold, no signal is transmitted, as depicted in step 108.

The signal may be transmitted to navigation devices 10. The signal may be transmitted in a broadcast mode, but may also be transmitted to navigation devices 10 is a point to point mode, for instance at the request of a navigation device 10, as will be further explained below. The signal notifies the navigation devices 10 of the changed road conditions and may comprise updated reference speeds and road segments or road for which these updated reference speeds apply.

An other way to determine the average vehicle density or average vehicle distance is to determine the ‘colour’ or contrast of a photographed and recognized road. If there is a lot of traffic, the road is filled with vehicles 50 and the ‘colour’ of the road is different from the colour of an empty road. An empty road has a certain solid monotonic (dark) colour. The presence of vehicles 50 changes this solid monotonic colour. Thus, traffic conditions can be determined not by recognizing particular vehicles 50 in the picture, but by comparing the ratio R between the number of pixels n_{dark} in the photograph belonging to a road or road segment with monotonic solid (dark) colour and the amount of pixels nₒₜₕₑᵣ with an other colour, all belonging to the road or road segment:

$$R = \frac{{n}_{other}}{{n}_{low}} .$$

If the ratio R is low, for instance below a certain predetermined threshold value, the photograph shows a lot of the road area. Traffic is considered normal and no signal needs to be generated. If the ratio R is high, for instance above a certain threshold value, traffic is considered dense and a signal may be generated.

In order to execute this alternative, the server 40 needs to be able to distinguish between a pixels belonging to the road and a pixels belonging to a vehicle 50. This may simply be done by determining a threshold value for the darkness and comparing the darkness of a pixel with this threshold value. It is also possible to first find all dark pixels and calculate the threshold dynamically.

It will be understood that this embodiment may also be used at night. Instead of recognizing vehicles 50 directly, the presence and location of a vehicle 50 is easily determined by detecting the light emitted by the head lights.

It will be understood that the average speed of the vehicles may also be computed in a different way, for instance, by using the amount of blur of the vehicles in the photo caused by the movement of the vehicles. In order to this, the exposure time used by the ground photographing device 31 may be chosen relatively long, such as for instance 0.5 seconds. For instance, at a speed of 50 km/h a vehicle travels approximately 7 meters in 0.5 seconds.

Based on the amount of blur, the speed of individual vehicles 50 can be determined, by measuring the length of the blur. Taking into the account the scale of photograph the distance traveled by a vehicle can be computed. Based on this, the speed of the vehicle can easily be computed. This can be done for all vehicles in the photograph. The average speed of the vehicles 50 in the photograph can be computed by averaging the individually determined speed values. This will be explained in more detail in the second embodiment.

### EMBODIMENT 2

According to a second embodiment, the satellite 30 is arranged to take at least two successive ground photographs of a same ground area. The at least two ground photographs are taken at a predetermined time-interval, for instance of 10 seconds.

The photographs are transmitted to a server 40 using the transmitter device 32. The server 40 is arranged to receive these at least two photographs, using input/output device 425.

The at least two photographs may further comprise a header with an identification of the photographs. The header may comprise information about the location and orientation of the photographs expressed in degrees of longitude and latitude, scale, point in time of the photograph etc.

The processor unit 411 uses known pattern recognition algorithms to recognize roads in the at least two photographs received from the satellite 30. This recognition step may be simplified by using the map data stored in the memory units 412, 413, 414, 415 as an input for the pattern recognition algorithms. The header information may be used to match the at least two ground photographs with the map data. Based on this, roads may be recognised and identified more easily by the pattern recognition algorithms, as it is easier to find a road if it is already known where to find it.

After roads have been recognized in the at least two photographs, the processor unit 411 is arranged to recognize vehicles 50 on a certain segment of the road. Again, pattern recognition algorithms known to a skilled person may be used for this.

By comparing different successive photographs, the speed of individual vehicles may be computed. Techniques are used to compare the positions of vehicles 50 as recognised in a first photograph with respect to the positions of the same vehicles 50 as recognised in a second photograph. Since most vehicles look alike, especially when photographed from above, the known computational algorithms are arranged to link vehicles in the first photograph to that same vehicle in the second photograph. This may be done by computing correlation values between the first and second photographs, as is for instance known from particle image velocimetry techniques used in fluid mechanics.

Additional information may be provided as an input to these computational algorithms imposing boundary conditions simplifying the computation. The boundary conditions may be that the directions of movement of vehicles in a road segment are all in the same direction. A further condition may be that the difference in speed of vehicles in the direct vicinity of each other may not exceed a predetermined threshold value.

In order to further simplify the computational algorithm, only vehicles having specific features may be taken into account. This allows easy recognition of that same vehicle in the second photograph. For instance, the algorithm may be arranged to only take into account trucks and/or red cars, as they are easy recognisable.

When the position of at least one vehicle is determined in the first photograph and the position of that same vehicle is determined in the second photograph, the speed of that vehicle can be computed. The time interval Δbetween the first and the second photograph can be computed, as the points of time of the first and second photograph are known, for instance from the header information. Also the distance travelled by the at least one vehicle can be determined by comparing its position in the first and second photograph. The scale of the first and second photographs are known from the header information, thus the real distance Δx can easily be computed from the measured distance within the photographs. Finally the speed v of the at least one vehicle 50 can be computed:

v=Δx/Δt.

In case the corresponding positions of more than one vehicle 50 are determined in the first and second photographs, a speed vᵢ may be computed for each vehicle:

ti vᵢ=Δxᵢ/Δt,
with i=1, 2, . .. , iₘₐₓ representing vehicles 50. From this an average vehicle speed v_{average} may be computed for that road segment, by averaging all determined individual vehicle speeds vᵢ:

$${v}_{average} = \frac{{\sum }_{i = 1}^{i = {i}_{max}} {v}_{i}}{{i}_{max}} .$$

The average speed v_{average} for that road segment is then compared to the reference speed values associated with certain roads or roads segments as stored in the memory units 412, 413, 414, 415. When a difference is detected, or when the difference exceeds a certain threshold, a signal may be transmitted to navigation devices 10 comprising information about this changed road situation. The determined average speed v_{average} may also be compared to a general minimum reference speed that is not associated with a certain road or road segment. Such a general reference speed may for instance have a value of 10 km/h. It is assumed that in case the average speed is below 10 km/h, traffic is jammed.

The signal may also comprise a new updated reference speed that is associated with that road or road segment. This information may be stored by the navigation device 10 and used when computing an “optimum route” or re-routing an already planned route.

FIG. 6 shows a flow chart of the program as performed by the processor unit 411 of the server 40 according to the second embodiment. In a first step 111, the input/output device 425 of the server 40 receives at least two ground photographs from the satellite 30. The at least two ground photographs also include header information.

In a second step 112, the processor unit 411 matches the at least two ground photographs with map data stored in the memory units 412, 413, 414, 415 to simplify the following pattern recognition step.

In a third step 113, the processor unit 411 performs a first pattern recognition step to recognise roads and other relevant items, in the at least two ground photographs as received from the satellite 30.

In a further step 114, the processor unit 411 applies further pattern recognition algorithms to recognise vehicles 50 on the earlier recognised roads.

In a further step 115, the processor unit 411 applies computational algorithms to compare the position of vehicles 50 in the first photograph with the positions of the same vehicles 50 in the second photograph and compute the individual speeds of the vehicles 50 based on the compared positions.

In a next step 116 the average speed of the vehicles is computed from the individual speeds of the vehicles 50 as computed in the former step 115.

In a seventh step 117, the average speed is compared to the speed associated with that road segment (reference speed) as stored in the memory units 412, 413, 414, 415. If a difference is determined, or if the difference exceeds a certain predetermined threshold, the processor unit 411 compiles a signal and controls the input/output device 425 to transmit the signal as depicted in step 118, for instance comprising an updated reference speed value for a certain road segment or road. If no difference is determined or the difference does not exceed a predetermined threshold, no signal is transmitted, as depicted in step 119.

It will be understood that more than two photographs may be used to determine the speeds of the vehicles. For instance, when three successive photographs are used, the speed of an individual vehicle may be computed based on the first and second photograph, and based on the second and third photograph. The outcome of both computations may be averaged to obtain a more accurate speed vᵢ.

Of course, errors may occur when a vehicle in the first photograph is linked to a vehicle in the second photograph, if it is not the same vehicle. This can be prevented by using more than two photographs. First a speed is computed of a vehicle 50 based on the first and second photograph. Based on this computed speed, a position of the vehicle in the third photograph can be predicted. When no (resembling) vehicle 50 is found at the predicted position or in the vicinity of the predicted position in the third photograph, the match between the first and second photograph probably was not correct. Of course, the fact that no (resembling) vehicle 50 was found at the predicted position in the third photograph may also be caused by a sudden change of speed of the vehicle.

The signal as generated by the server 40 may be transmitted to navigation devices 10, for instance mounted in vehicles 50 as shown in FIG. 3. This will be further explained below.

It will be understood that this embodiment may also be used at night. Instead of recognizing vehicles 50 directly, the presence and location of a vehicle may be determined by detecting the light emitted by the head lights.

### EMBODIMENT 3

According to a further embodiment, the navigation device 10 may be arranged to perform the functionality of the server 40 described above. This means that the navigation device 10 is capable of receiving at least one photograph, match the photograph with map data, recognise roads and road segments in the photograph, recognise vehicles, estimate an average speed for a certain road or road segment and compare the estimated average speed to a stored reference speed associated with that road or road segment. This may be done using all sorts of techniques described above, thus based on one photograph or based on more photographs.

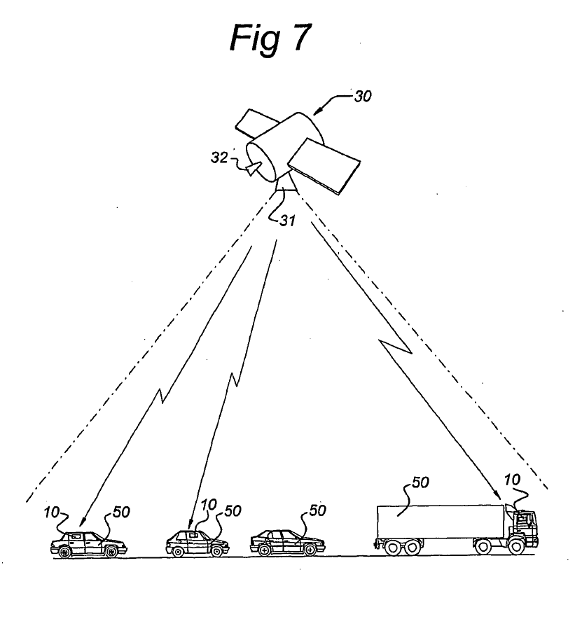

The navigation device 10 may therefore be arranged to be in direct communication with the satellite 30, using input/output device 25, omitting the server 40, as is schematically depicted in FIG. 7. The satellite 30 may send one or more photographs to a navigation device 10. The navigation device 10 is arranged to perform steps described above referring to the server 40. This way, the navigation device 10 can compute its own traffic information.

According to an alternative, the navigation device 10 and the satellite 30 may be arranged to communicate via at least one intermediate server (not shown). However, according this embodiment, this intermediate station is only arranged to transmit photographs from the satellite 30 to the navigation device 10 and not to perform the functionality of server 40 as described above.

According to this embodiment, the navigation device 10 may request the satellite 30 (or the intermediate server) to transmit recent photographs of a certain location. This location may for instance be determined by the navigation device 10 based on a current position, or based on a planned route.

### EMBODIMENT 4

It will be understood that all embodiments above may be used to retrieve and distribute traffic information in general, being more than just information about the amount of traffic or the updated reference speed of average speed for a certain road or road segment. All techniques described above may also be used to obtain information about all kinds of traffic conditions, such as weather conditions, availability of parking places/spaces.

For instance, based on the ground photograph the server 40 may determine whether a car park has available parking places. This may be done by first matching the photograph with stored map data, as described above. The map data may comprise detailed information about a car park, including information about the position of parking places. Next, the server 40 may use for instance pattern recognition techniques to recognise whether or not a vehicle 50 is present at a parking place. The information about the availability of parking places is then transmitted to the navigation device 10 by the server 40 using input/output device 425 and input/output device 25.

The information could be presented to the user. Alternatively, the information may be used by the navigation device 10 to navigate the vehicle 50 to an available parking place, or in case a car park has no available parking places, to another car park.

Of course, this embodiment may also be executed without using server 40, but by equipping navigation device 10 with the functionality to perform the steps of this embodiment.

All embodiments described above may be improved by applying data processing steps to the photographs received from the satellite 30. These processing steps may comprise adjusting the brightness, contrast. Also all kind of suitable filters may be used. Techniques may be used to increase the quality of the images in rainy and/or cloudy conditions.

Also, all the embodiments described above may also be used during night time, when it is dark and visibility is low. In that case, the vehicles 50 can not be recognized directly. However, the vehicles 50 may be easily recognized by detecting the light emitted by the (head) lights of the vehicles 50.

Recognizing vehicles 50 by the emitted light of their (head) lights can be used in all embodiments discussed above, such as to determine the density of the traffic, to determine average speed by measuring the amount of blur of a vehicle in a picture, to determine the ratio between dark pixels and brighter pixels, to compare more than one photograph etc.

The camera 31 may be any kind of camera, such as a camera that is sensitive to electromagnetic radiation that is not visible for the human eye. The camera 31 may be an infrared camera that enables use at night.

In all embodiments described above, the server 40 is arranged to send a signal to navigation devices 10 in case a relevant traffic condition is determined. This signal may comprise information about the changed road condition, for instance comprising an indication of the road section and a new reference speed associated with that road section. This information transmitted to the navigation devices 10 may than be used by the navigation devices 10 when planning a new route or replanning an already planned route.

The server 40 may send this signal directly to navigation devices 10 using input/output device 425. However, server 40 may also send the signal to navigation devices 10 via one or more other satellites (possibly including satellite 30) or ground stations. It will be understood that all sorts of transmission techniques and/or protocols may be used to transmit the signal from the server 40 to the navigation devices 10.

Navigation devices 10 comprise an input/output device 25 to receive the transmitted signals. The processor unit 11 of the navigation device 10 is arranged to store the signal in memory units 12, 13, 14, 15, and use the information when planning a route or re-routing an already planned route.

According to a further alternative, the server 40 may be arranged to only transmit the signal to navigation devices 10 in the vicinity of the changed road condition. This may be done by only transmitting the signal in the vicinity of the changed road condition.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein. It will be understood by a skilled person that all software components may also be formed as hardware components.

The descriptions above are intended to be illustrative, not limiting. Thus, it will be apparent to one skilled in the art that modifications may be made to the invention as described without departing from the scope of the claims set out below.

1. Method for determining traffic information, comprising:
receiving at least one photograph of a portion of the earth's surface including at least one road segment using an input/output device;
recognizing a number of vehicles on the at least one road segment in the at least one received photograph using a processor unit; and
determining traffic information based on the number of recognized vehicles.

2. Method according to claim 1, wherein the recognition of the number of vehicles is done using pattern recognition techniques.

3. Method according to claim 2, wherein map data is used as input for the pattern recognition techniques.

4. Method according to claim 1, further comprising:
computing a speed of the number of recognized vehicles based on the at least one received photograph.

5. Method according to claim 4, wherein the speed of the number of vehicles is computed by
determining a vehicle density for a road segment, and
estimating, from the vehicle density, an average speed of the number of recognized vehicles in the road segment.

6. Method according to claim 5, wherein the vehicle density for a road segment is determined by determining a ratio between a number of pixels in the photograph belonging to a road or road segment with a first color and a number of pixels with an other color.

7. Method according to claim 4, wherein the speed of the number of recognized vehicles is computed by
determining an amount of blur of the number of recognized vehicles.

8. Method according claim 4, further comprising:
receiving at least two photographs of a piece of the earth from a photographing device, the first photograph being made at a first point in time and the second photograph being made at a second point in time,
recognizing a number of vehicles in the first photograph,
recognizing a number of vehicles in the second photograph,
computing the distance traveled in between the first and second photograph by at least a part of the number of vehicle recognized in both the first and second photograph, and
computing a speed of the number of recognized vehicles using the computed distance and the first and second point in time.

9. Method according to claim 8, further comprising:
comparing the computed speed of the number of recognized vehicles to a reference speed associated with the road segment the number of recognized vehicles is recognized on.

10. Method according to claim 9, further comprising:
comparing the computed speed of the number of recognized vehicles to a predetermined minimum speed.

11. Method according to claim 1, further comprising:
determining the positions of the at least one recognized vehicle;
comparing the determined position with map data, the map data comprising information about parking places, and
determining availability of the parking places.

12. Method according to claim 1, further comprising:
compiling a signal including the determined traffic information; and
transmitting the compiled signal.

13. Device comprising: -
put-output device;
memory units; and
a processing unit to communicate with other devices using the input-output device, and to communicate with the memory units, the device being arranged to
receive at least one photograph of a portion of the earth's surface comprising at least one road segment using the input-output device,
recognize a number of vehicles on the at least one road segment in the at least one received photograph using the processing unit, and
determine traffic information based on the number of recognized vehicles.

14. Device according to claim 13, wherein the device is a server, arranged to compile a signal based on the determined traffic information and transmit the signal using the input-output device.

15. Device according to claim 14, wherein the device is a navigation device arranged to plan a route.

16. Device according to claim 15, wherein the navigation device is arranged to plan a route based on the determined traffic information.

17. Vehicle, comprising a device according to claim 13.

18. Computer program, when loaded on a computer arrangement, arranged to perform the method of claim 1.

19. Data carrier, comprising a computer program according to claim 18.
